(19) United States
(12) Patent Application Publication
(10) Pub. No.: US 2011/0109840 A1
(43) Pub. Date: May 12, 2011

(54) LIGHT GUIDE UNIT, SURFACE LIGHT SOURCE DEVICE AND LIQUID CRYSTAL DISPLAY DEVICE

(75) Inventors: Takeshi Masuda, Osaka-shi (JP); Yuhsaku Ajichi, Osaka-shi (JP); Shin Ito, Osaka-shi (JP)

(73) Assignee: SHARP KABUSHIKI KAISHA, Osaka-shi, Osaka (JP)

(21) Appl. No.: 13/000,640

(22) PCT Filed: Apr. 17, 2009
(86) PCT No.: PCT/JP2009/057755

§ 371 Date: Dec. 22, 2010

(30) Foreign Application Priority Data
Jul. 3, 2008 (JP) 2008-174769

(51) Int. Cl. G02F 1/1335; F21V 7/22

(52) U.S. Cl. 349/62; 362/606; 362/607

(57) ABSTRACT

The present invention achieves a light guide unit capable of, with use of minimum-sized reflection means, (i) preventing light from directly leaking out from a light guide through a surface of the light guide and thus preventing luminance unevenness, and also (ii) suppressing an increase in production costs. Specifically, reflection means (8) is provided on an upper surface of a light guide part (2a) so as to cause light entered a light guide (2) to travel toward inside of the light guide (2). The reflection means (8) extends from one intersection (P) of first intersections so as to cover a region, of the upper surface of the light guide part (2a), which faces a light incidence surface (9) right above a light source (6). Each of the first intersections is an intersection of (i) a straight line extending at an angle θ to a vertical line (M) and passing through a second intersection and (ii) the upper surface of the light guide part (2a). The one intersection (P) of the first intersections is furthermost from the light source (6) among the first intersections. The vertical line (M) extends from an edge, of the light source (6), which is closest to the light emitting surface (2c) toward the light incidence surface (9). The second intersection is an intersection at which the light incidence surface (9) and the vertical line (M) intersect.

### TECHNICAL FIELD

The present invention relates to (i) a light guide unit included in an illumination device used as a backlight of a liquid crystal display device etc., (ii) a surface light source device including the light guide unit, and (iii) a liquid crystal display device including the surface light source as a backlight.

### BACKGROUND ART

A liquid crystal display device has become rapidly widespread recently in place of a cathode ray tube (CRT) display device. Such a liquid crystal display device is for widely use in an electronic device such as a liquid crystal display television, a monitor, or a mobile phone, because the liquid crystal display device has the advantages that it is energy-saving, thin, and light. It is possible to further put such advantages to good use by, for example, improving an illumination device (a so-called backlight), which is provided behind the liquid crystal display device.

The illumination device is broadly classified into a side illumination device (also called “an edge illumination device”) and a direct illumination device. The side illumination device is arranged such that (i) a light guide is provided behind a liquid crystal display panel and (ii) a light source is provided on a lateral end of the light guide. Such a side illumination device uniformly irradiates the liquid crystal display panel as follows. The light emitted from the light source is reflected by the light guide, and is then directed toward the liquid crystal display panel. According to the arrangement, it is possible to achieve a thinner illumination device that is excellent in uniformity of luminance, although such an illumination device is not so excellent in luminance level. Because of its excellent uniformity of luminance, the side illumination device is mainly employed in a medium-small size liquid crystal display for use in a device such as a mobile phone or a laptop computer.

The direct illumination device is such that a plurality of light sources are provided behind the liquid crystal panel so as to directly irradiate the liquid crystal panel. The direct illumination device thus easily achieves high luminance even in a case where it is used in a large display. Therefore, the direct illumination device is mainly employed in a liquid crystal display that is as large as 20 inches or more. However, a conventional direct illumination device is some approximately 20 mm to 40 mm in thickness, which is a problem to be solved for further reducing a thickness of the display.

In order to further reduce a thickness of a large liquid crystal display, the light sources and the liquid crystal display panel should be provided closer to each other. In doing so, the number of light sources needs to be increased so as to achieve uniformity of luminance of the illumination device. However, the increase in the number of the light sources causes cost increase. Under such circumstances, it is desired to develop, without increasing the number of the light sources, an illumination device that is thin and excellent in uniformity of luminance.

Conventionally, in order to apply the side illumination device to the large liquid crystal display, development of a so-called tandem illumination device has been actively carried out. The tandem illumination device is configured such that a plurality of light guide units, each of which is constituted by a combination of a light source and a light guide, are arranged so as to achieve a thin illumination device that is large in area size and is more excellent in uniformity of luminance.

For example, Patent Literature 1 discloses a configuration in which light emitting surfaces of respective light emitting parts can be joined together, thereby achieving a large and uniform surface light source device.

FIG. 7 illustrates how a conventional light guide unit is configured. (a) of FIG. 7 is a perspective view illustrating main constituents of the conventional light guide unit. (b) of FIG. 7 is a see-through view illustrating the main constituents as seen from above. (c) of FIG. 7 is a cross-sectional view taken along line 1C-1C′ of (b) of FIG. 7.

As illustrated in FIG. 7, the light guide 111 as a whole is in a rectangular shape when viewed from above. The light guide 111 has (i) a pair of end surfaces 111c and 111d, which face each other and (ii) a light incidence surface 111a and a light output surface 111b which face each other.

The end surfaces 111c and 111d, which face each other, of the light guide 111 are inclined at an identical angle. The light incidence surface 111a is along a base at an acute angle-side of a side surface.

Further, a bar-shaped light source 112 is provided along the light incidence surface 111a of the light guide 111. The bar-shaped light source 112 emits light, part of which directly transmits the light incidence surface 111a and the other part of which is diffusely reflected by a lamp reflector 113 so that it transmits the light incidence surface 111a.

Patent Literature 1 further teaches that the light entered through the light incidence surface 111a contains (i) one component that is diffusely reflected by a light reflection plate 114 so that it travels inside the light guide 111 and is then emitted outward through the light output surface 111b and (ii) the other component that is diffusely reflected by light reflection plates 115 and 116 so that it is emitted outward through the light output surface 111b. Under such circumstances, although intensity of the light is slightly intense in the vicinity of the bar-shaped light source 112, luminance unevenness in light emitting surfaces as a whole can be suppressed by (a) providing each bar-shaped light source 112 at an end of the light guide 111 and (b) evenly distributing positions of the bar-shaped light sources 112.

Patent Literature 1 further teaches that, according to this configuration, (i) the bar-shaped light source 112 is provided on a side of the light guide 111 opposite to the light output surface 111b and (ii) the end surfaces 111c and 111d, which face each other, of the light guide 111 are inclined at an identical angle. This makes it possible to join together a plurality of light output surfaces 111b of respective light guides 111, thereby achieving a large and uniform surface light source device.

Patent Literature 2 discloses a surface light source device 201 (see FIG. 8). The surface light source device 201 employs a plurality of LED array light sources 202, in each of which LEDs that emit monochromatic lights of different wavelengths are arranged parallel to one another at predetermined gaps.

The surface light source device 201 includes first light guides 204, each of which (i) has a horizontal upper surface and a lower surface at an angle to the horizontal upper surface and thus (ii) has a wedge-shaped cross-sectional surface. An end surface of each of the first light guides 204, which end surface is at a thicker side, faces a corresponding one of the LED array light sources 202 via a corresponding first monochromatic light mixing member (light guide part) 208.

Each of second light guides 206 has a horizontal lower surface and an upper surface at an angle to the horizontal lower surface, and thus has a wedge-shaped cross-sectional surface. An end surface of each of the second light guides 206, which end surface is at a thicker side opposite to that of a corresponding one of the first light guides 204, faces a corresponding one of the LED array light sources 202 via a corresponding second monochromatic light mixing member (light guide part) 210.

Further, reflection shield members 214, which are for reflecting light from the LED array light sources 202 so as to block the light, are provided above the LED array light sources 202, the first monochromatic light mixing members (light guide parts) 208, and the second monochromatic light mixing members (light guide parts) 210.

Patent Literature 2 teaches that, according to this configuration, a sufficient distance is secured for mixing light emitted from each of the LED array light sources 202, thereby achieving an LED surface light source device 201 that is excellent in uniformity of luminance and has a compact structure.

### CITATION LIST

### Patent Literature 1

Japanese Patent Application Publication, Tokukaihei, No. 11-203925 A (Publication Date: Jul. 30, 1999)

### Patent Literature 2

Japanese Patent Application Publication, Tokukai, No. 2006-269365 A (Publication Date: Oct. 5, 2006)

### SUMMARY OF INVENTION

### Technical Problem

According to the conventional surface light source devices disclosed in Patent Literatures 1 and 2, light guides are configured such that reflection members are provided in the vicinities of light sources. This is for preventing luminance unevenness which occurs because, in the vicinity of each of the light sources, light emitted from the light source does not travel toward inside of a corresponding one of the light guides and is emitted outward through a surface of the light guide. Note here that, the reason why the light is emitted outward in the vicinity of the light source is because, in the vicinity of the light source, there are a lot of light components each of which strikes an upper surface of the light guide with an angle of incidence smaller than a total reflection critical angle that depends on material from which the light guide is made.

However, since these configurations have not at all taken into consideration specific regions to be covered by the reflection members, there have been the following problems.

As illustrated in (c) of FIG. 7, according to the light guide 111 included in the conventional surface light source device of Patent Literature 1, light emitted from the light source 112 contains light components including a light L. The light L strikes the light output surface 111b, which is not provided with the light reflection plate 114, with an angle of incidence smaller than a total reflection critical angle that depends on material from which the light guide 111 is made. The light L is thus directly emitted outward through the light output surface 111b.

Such a light L directly leaks out through the light output surface 111b. This leads to an increase in luminance of the light output surface 111b in the vicinity of the light source, and eventually leads to luminance unevenness.

Specifically, according to Patent Literature 1, the light reflection plate 114 is too short to sufficiently cover a region that needs to be covered. Therefore, part (i.e., the light L) of light is emitted outward directly through the light output surface 111b, thereby causing luminance unevenness. This will lead to a reduction in light intensity of an illumination device and a reduction in efficiency of the illumination device.

On the other hand, as illustrated in FIG. 8, according to the light guides 204 and 206 included in the conventional surface light source device 201 of Patent Literature 2, reflection members 214 are provided so as to cover an entire regions above the light sources 202, the first monochromatic light mixing members (light guide parts) 208, and the second monochromatic light mixing members (light guide parts) 210. This configuration has not at all taken into consideration regions to be covered by the reflection members 214.

That is, the reflection members 214 are provided to cover not only regions where the reflection members 214 are substantially effective for reflecting light, but also regions other than the above regions.

Specifically, each of the reflection members 214 even covers regions where (i) an angle of incidence of light emitted from each of the light sources 202 to an upper surface of a corresponding one of the first monochromatic light mixing members (light guide parts) 208 meets the total reflection condition and (ii) an angle of incidence of the light emitted from the each of the light sources 202 to an upper surface of a corresponding one of the second monochromatic light mixing members (light guide parts) 210 meets the total reflection condition.

In the regions where the total reflection condition is met, light is totally reflected and no light is emitted outward even without the reflection members 214.

If the reflection members 214 are provided in such a way as described in Patent Literature 2, production costs are increased.

The present invention has been made in view of the problems, and an object of the present invention is to provide (i) a light guide unit capable of, with use of minimum-sized reflection means, (a) preventing light from directly leaking out from a light guide through a surface of the light guide and thus preventing luminance unevenness and also (b) suppressing an increase in production costs, and (ii) a surface light source device including the light guide unit. The above object is achieved by accurately specifying a length of the reflection means effective for reflecting light, which reflection means is provided in a light guide unit including: a light source; and a light guide being constituted by (I) a light emitting part having a light emitting surface through which light from the light source is emitted in a form of plane emission and (II) a light guide part guiding the light from the light source to the light emitting part. Another object of the present invention is to provide a liquid crystal display device including the surface light source device, which liquid crystal device has improved display quality.

### Solution to Problem

In order to attain the above object, a light guide unit in accordance with the present invention includes: a light source; a light guide being constituted by (i) a light emitting part having a light emitting surface through which light from the light source is emitted in a form of plane emission and (ii) a light guide part for guiding the light from the light source to the light emitting part; and reflection means provided on an upper surface of the light guide part so as to cause light, which entered the light guide, to travel toward inside of the light guide, the light guide having a shape that allows for overlap of a neighboring light guide with the light guide, the reflection means extending from one of first intersections so as to cover a region, of the upper surface of the light guide part, which faces a light incidence surface right above the light source, where: each of the first intersections is an intersection of (a) a straight line extending at an angle θ to a vertical line and passing through a second intersection and (b) the upper surface of the light guide part; the one of the first intersections is furthermost from the light source among the first intersections; the vertical line extends from an edge, of the light source, which is closest to the light emitting surface toward the light incidence surface; and the second intersection is an intersection at which the vertical line and the light incidence surface intersects, the angle θ satisfying the following Equation 1:

θ=α−φ (Equation 1),

where

φ an angle of inclination of (I) either one of the upper surface and a lower surface, which are parallel with each other, of the light guide part of the light guide to (II) an extended plane of a substrate on which the light source is provided, α is a total reflection critical angle which depends on material from which the light guide is made, and α≧φ.

### <Necessity for Specification of Length of Reflection Means>

Conventionally, reflection means has been provided in a region, in the vicinity of a light source, of a light guide included in a surface light source device. This is for preventing luminance unevenness caused by light emitted from the region, in the vicinity of the light source, of the light guide. Note here that the reason why the light is emitted from the region in the vicinity of the light source is because, in the vicinity of the light source, there are a lot of light components each of which strikes an upper surface of the light guide with an angle of incidence smaller than a total reflection critical angle that depends on material from which the light guide is made.

However, to date, no concrete suggestion etc. has been made as to a region in which the reflection means needs to be provided. Therefore, problems have been present respectively (i) in a case where the reflection means covers an unnecessarily large region and (ii) in a case where the reflection means is too small to sufficiently cover the region that needs to be covered by the reflection means.

In the case where the reflection means covers the unnecessarily large region, such reflection means covers also a region where an inner surface of the light guide totally reflects light even without the reflection means. This causes a reduction in use efficiency of the reflection means and an undue increase in production costs.

On the other hand, in the case where the reflection means is too small to sufficiently cover the region that needs to be covered by the reflection means, light that strikes the upper surface of the light guide with an angle of incidence smaller than the total reflection critical angle is emitted from the light guide through a region not covered by the reflection means. This causes luminance unevenness in a light emitting surface.

For these reasons, it is necessary to accurately specify the length of the reflection means to be provided.

### <Specification of Length of Reflection Means>

The reflection means needs to be provided on the upper surface of a light guide part of the light guide in such a way as to cover a region extending to a certain point. This point is a point at which a light beam emitted from an edge, of the light source, which is closest to the light emitting surface strikes the upper surface of the light guide with an angle of incidence which meets the total reflection condition.

In a region where the light beam emitted from the edge, of the light source, which is closest to the light emitting surface strikes the upper surface of the light guide part with an angle of incidence smaller than the total reflection critical angle, the light beam directly leaks out through the surface of the light guide without traveling inside the light guide. In view of this, such a region needs to be covered by the reflection means.

On the other hand, in a region where the light beam emitted form the edge, of the light source, which is closest to the light emitting surface strikes the upper surface of the light guide part with an angle of incidence larger than or equal to the total reflection critical angle, the light beam is totally reflected by the light guide and none of the light beam directly leaks out through the surface of the light guide. In view of this, such a region does not need to be covered by the reflection means.

That is, according to the configuration, the reflection means is provided in a region extending to a boundary point between the region that needs to be covered by the reflection means and the region that does not need to be covered by the reflection means. The boundary point is found from (i) the total reflection critical angle that depends on material from which the light guide is made and (ii) an angle of inclination of (a) either one of the upper and lower surfaces, which are parallel with each other, of the light guide part of the light guide to (b) an extended plane of a substrate on which the light source is provided. Accordingly, it is possible to achieve a light guide unit capable of, with use of minimum-sized reflective means, (I) preventing light from directly leaking out from the light guide through the surface of the light guide and thus preventing luminance unevenness and also (II) suppressing an increase in production costs.

This is more specifically described below. Assume that an angle between a light beam and a vertical line is θ. Note here that the vertical line extends from an edge, of the light source, which is closest to the light emitting surface toward the light incidence surface right above the light source. The light beam passes through an intersection at which the light incidence surface and the vertical line intersect. In a case where the light beam strikes the upper surface, of the light guide part of the light guide, which is at an angle of inclination φ to an extended plane of the substrate on which the light source is provided, an angle of incidence of the light beam is θ+φ.

In a region where the angle of incidence θ+φ is larger than or equal to the total reflection critical angle α, the incident light is totally reflected by the light guide. That is, such a region does not need to be covered by the reflection means.

On the other hand, in a region where the angle of incidence θ+φ is smaller than the total reflection critical angle α, the incident light directly leaks out through the surface of the light guide without traveling inside the light guide. That is, such a region needs to be covered by the reflection means.

That is, by finding a point at which the angle of incidence θ+φ is equal to the total reflection critical angle α, it is possible to find a boundary point between the region that needs to be covered by the reflection means and the region that does not need to be covered by the reflection means.

The angle of inclination φ of the light guide part depends on shape of the light guide, whereas the total reflection critical angle α depends on material from which the light guide is made. In view of this, the angle θ can be found through the following equation:

θ=α−φ,where α≧φ (Equation 1)

The angle θ is an angle between (i) the vertical line extending from an edge, of the light source, which is closest to the light emitting surface toward the light incidence surface right above the light source and (ii) the light beam passing through the intersection at which the light incidence surface and the vertical line intersect. The boundary point between the region that needs to be covered by the reflection means and the region that does not need to be covered by the reflection means depends on the angle θ.

Further, the angle of inclination φ influences a thickness of the light guide. In view of this, the angle of inclination φ needs to be smaller than or equal to the total reflection critical angle α in order to achieve a thin light guide.

The light guide unit in accordance with the present invention is preferably configured such that α=φ.

According to the configuration, shape of the light guide part of the light guide and material from which the light guide is made are selected so that the angle of inclination φ is equal to the total reflection critical angle α. The angle of inclination φ is an angle of inclination of (i) either one of the upper and lower surfaces, which are parallel with each other, of the light guide part of the light guide to (ii) the extended plane of the substrate on which the light source is provided. The total reflection critical angle α depends on material from which the light guide is made.

Therefore, according to Equation 1, the angle θ is found to be 0. Accordingly, the reflection means, which causes light entered the light guide to travel toward inside of the light guide, can be provided on the upper surface of the light guide part so as to cover a region, of the upper surface of the light guide part, which faces the light incidence surface and extends from an intersection. The intersection is an intersection of a straight line extending at the angle θ (=0) and the upper surface, of the light guide part, which faces the light incidence surface.

According to the configuration, it is possible to achieve a light guide unit capable of, with use of minimum-sized reflection means, (i) preventing light from directly leaking out from a light guide through a surface of a light guide and thus preventing luminance unevenness and also (ii) suppressing an increase in production costs.

The light guide unit in accordance with the present invention is preferably configured such that: the light incidence surface serves as a part of an inner surface of a light entrance part of the light guide unit, and the light entrance part has a space for accommodating the light source in such a way as to cover the light source.

According to the configuration in which the light source is covered by the light entrance part of the light guide, there exists, around the light source, a surface not parallel with the light incidence surface.

The surface not parallel with the light incidence surface is, for example, a flat surface at an angle of inclination to the light incidence surface, a curved surface with continuously varying angles to the light incidence surface, or the like. Note, however, that the surface is not limited to these examples.

A light, which entered the light guide through the surface not parallel with the light incidence surface, contains a lot of light components each of which strikes the upper surface of the light guide part of the light guide with a large angle of incidence (i.e., light components each of which strikes the light guide part with an angle of incidence larger than or equal to the total reflection critical angle that depends on material from which the light guide is made). Such light components eventually travel inside the light guide part by being totally reflected by the light guide part.

While the reflection means of 100% reflectance does not exist, the light guide under total reflection condition is of 100% reflectance in theory. In view of this, an increase in an amount of light to enter the light guide through the surface not parallel with the light incidence surface will cause an increase in an amount of light that is reflected by the light guide of 100% reflectance.

For this reason, according to the configuration, it is possible to achieve a light guide unit that is excellent in use efficiency of light.

In order to attain the above object, a surface light source device in accordance with the present invention includes: the light guide unit; and an optical sheet on the light emitting surface of the light guide unit.

One example of the optical sheet is a diffusing plate, which is approximately 2 mm to 3 mm in thickness and is provided at a distance of several millimeters from the light emitting surface of the illumination device. Note, however, that the thickness of the optical sheet and the distance from the illumination device are not limited to those described above.

In order to secure uniformity of luminance that is high enough for the surface light source device to sufficiently exert its function, for example, the diffusing plate can further have, stacked on its upper surface, an optical sheet having a plurality of functions such sheet as a diffusing sheet, a prism sheet, a polarized reflection sheet, or the like, which is approximately several hundreds micrometers in thickness.

The above thickness and configuration are mere examples, and therefore the thickness and configuration are not limited to those described above.

According to the configuration, it is possible to achieve a thin surface light source device in which uniformity of luminance of a light emitting surface is more improved.

In order to attain the above object, a liquid crystal display device in accordance with the present invention includes, as a backlight, the foregoing surface light source device.

Since the configuration includes, as a backlight, the thin surface light source device in which uniformity of luminance of the light emitting surface is more improved, it is possible to achieve a thin liquid crystal display device having excellent display quality.

### Advantageous Effects of Invention

As described so far, the light guide unit in accordance with the present invention is configured such that: the reflection means for causing light, which entered the light guide, to travel toward inside of the light guide is provided on the upper surface of the light guide part. Such reflection means extends from one of the first intersections so as to cover the region, of the upper surface of the light guide part, which faces the light incidence surface. Each of the first intersections is the intersection of (i) the straight line extending at the angle θ to the vertical line and passing through the second intersection and (ii) the upper surface of the light guide part. The one of the first intersections is furthermost from the light source among the first intersections. The second intersection is the intersection at which the light incidence surface and the vertical line intersect.

Further, as described earlier, the surface light source device in accordance with the present invention includes the light guide unit, and has the optical sheet on the light emitting surface of the light guide unit.

Further, as described earlier, the liquid crystal display device in accordance with the present invention includes the surface light source device as a backlight.

Accordingly, it is possible to achieve a light guide unit capable of, with use of minimum-sized reflection means, (i) preventing light from directly leaking out from a light guide through a surface of the light guide and thus preventing luminance unevenness and also (ii) suppressing an increase in production costs.

Further, it is possible to achieve a surface light source device including the light guide unit, which surface light source is thin and has more improved uniformity of luminance.

Further, it is possible to achieve a liquid crystal display device including the surface light source device as a backlight, which liquid crystal display device is thin and has excellent display quality.

### BRIEF DESCRIPTION OF DRAWINGS

FIG. 1 shows cross-sectional views each illustrating a light guide unit of one embodiment of the present invention. (a) of FIG. 1 is a view schematically illustrating how the light guide unit is configured. (b) of FIG. 1 is an enlarged view illustrating a chief portion of the light guide unit. (c) of FIG. 1 is a view specifically illustrating a region, of the light guide unit, in which reflection means is provided.

FIG. 2 shows cross-sectional views each illustrating a light guide unit of another embodiment of the present invention. (a) of FIG. 2 schematically illustrates how the light guide unit is configured. (b) of FIG. 2 specifically illustrates a region, of the light guide unit, in which reflection means is provided.

FIG. 3 is a cross-sectional view schematically illustrating how a surface light source device included in a liquid crystal display device of one embodiment of the present invention is configured.

FIG. 4 is a perspective view schematically illustrating how an illumination device included in the liquid crystal display device of one embodiment of the present invention is configured.

FIG. 5 is a cross-sectional view illustrating how the liquid crystal display device of one embodiment of the present invention is configured.

FIG. 6, showing one embodiment of the present invention, is a cross-sectional view schematically illustrating how a light guide unit is configured in a case where minimum-length reflection means is provided. FIG. 6 is also a view on the basis of which to explain how to specify the length of the reflection means.

FIG. 7 illustrates how a conventional light guide unit is configured. (a) of FIG. 7 is a perspective view illustrating main constituents of the conventional light guide unit. (b) of FIG. 7 is a see-through view illustrating the main constituents as seen from above. (c) of FIG. 7 is a cross-sectional view taken along line 1C-1C′ of (b) of FIG. 7.

FIG. 8 is a cross-sectional view schematically illustrating how a conventional surface light source device is configured.

### DESCRIPTION OF EMBODIMENTS

One example of an embodiment of the present invention is specifically described below with reference to the drawings. Note however that, unless otherwise stated, size, material, shape, positional relation, and the like of each constituent described in the present embodiment are mere examples for explaining the present embodiment, and are not intended to limit the present invention to those described in the present embodiment.

A light guide unit of one embodiment in accordance with the present invention is a light guide unit capable of, with use of minimum-sized reflection means, (i) preventing light from directly leaking out from a light guide through a surface of the light guide and thus preventing luminance unevenness and also (ii) suppressing an increase in production costs.

A surface light source device of one embodiment in accordance with the present invention includes such a light guide unit, and therefore is thin and has more improved uniformity of luminance of a light emitting surface.

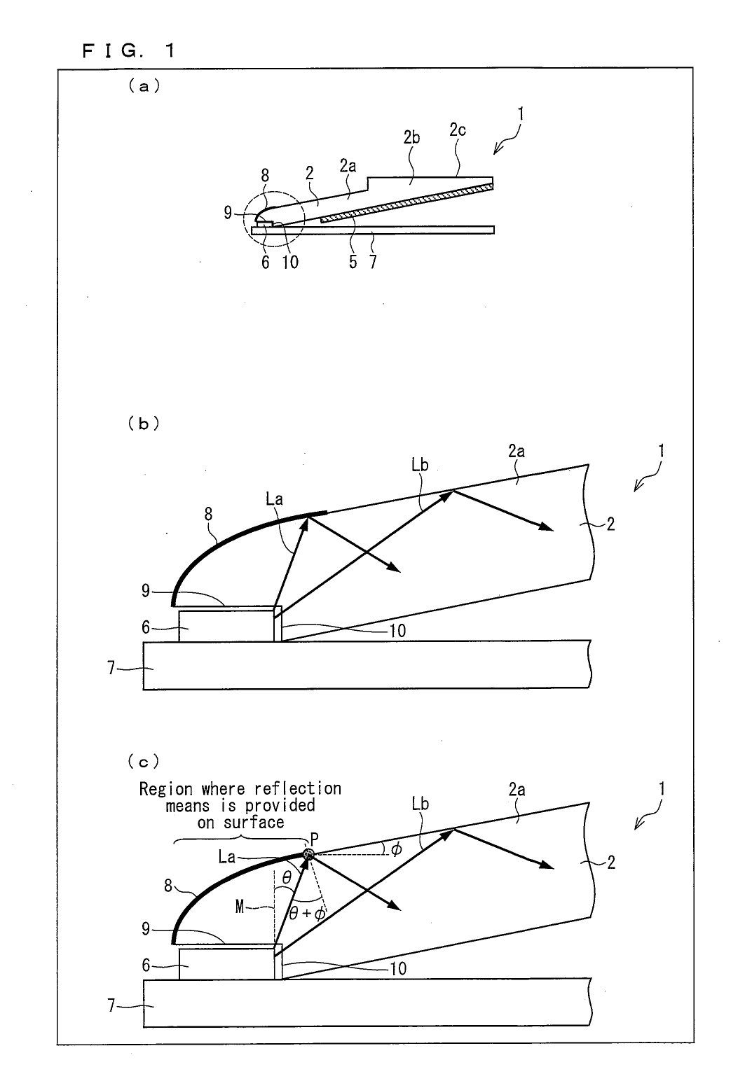

A liquid crystal display device of one embodiment in accordance with the present invention includes the surface light source device as a backlight, and therefore is thin and excellent in display quality. These are described below with reference to FIGS. 1 through 6.

### Embodiment 1

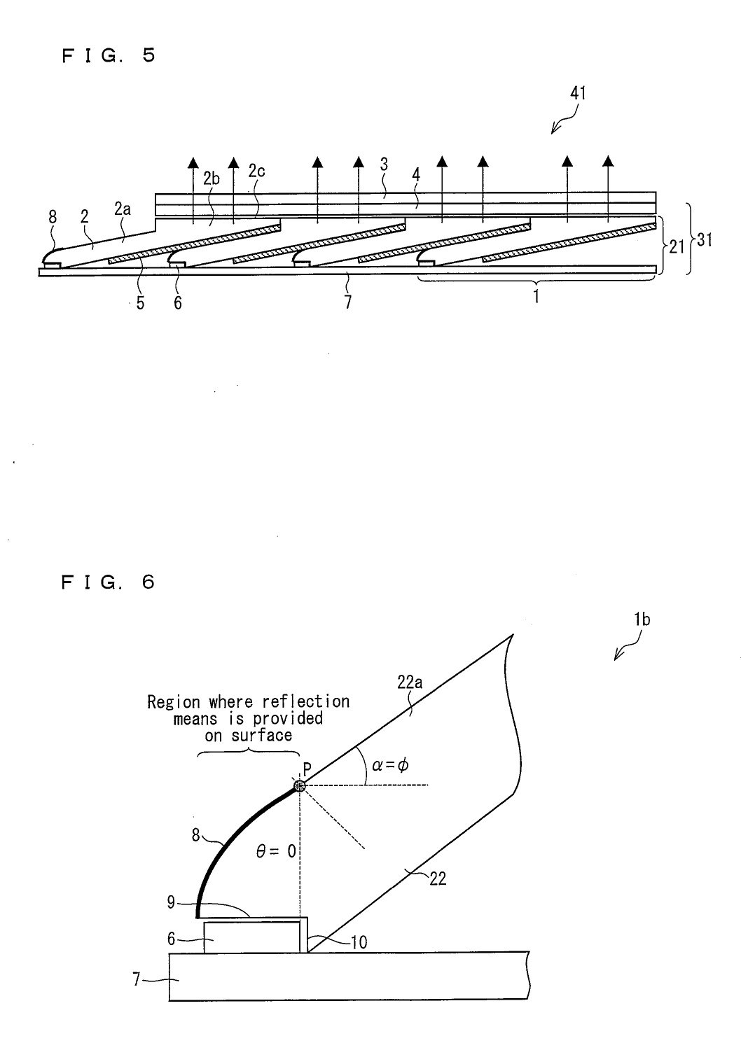

FIG. 5 is a cross-sectional view illustrating how a liquid crystal display device of one embodiment in accordance with the present invention is configured.

FIG. 5 illustrates how a liquid crystal display device 41 is configured. The liquid crystal display device 41 includes a surface light source device 31 as a backlight. The surface light source 31 includes light guide units 1, each of which is constituted by (i) a light source 6 and (ii) a light guide 2 which (a) causes light from the light source 6 to be emitted in a form of plane emission and (b) has a shape that allows for partial stacking of a light emitting part 2b of another light guide 2 on the light guide 2.

As illustrated in FIG. 5, a liquid crystal display device 41 further includes a liquid crystal display panel 3. The surface light source device 31 (backlight) is provided behind the liquid crystal display panel 3 so as to emit light toward the liquid crystal display panel 3.

How each of the light guide units 1 is configured is specifically described below with reference to FIGS. 1 and 5.

(a) of FIG. 1 is a cross-sectional view schematically illustrating how a light guide unit 1 is configured. (b) of FIG. 1 is an enlarged cross-sectional view illustrating a chief portion of the light guide unit 1. (c) of FIG. 1 is a view on the basis of which to explain how to specify a length of reflection means 8 to be provided in the light guide unit 1.

The light guide unit 1 includes: the light guide 2, a reflection sheet 5, the light source 6, and a substrate 7 on which the light source 6 is provided. The light guide unit 1 diffuses light from the light source 6 so as to emit the light in a form of plane emission.

### <Explanation for Light Guide 2>

As illustrated in FIG. 5, the light guide 2 causes the light from the light source 6 to be emitted, in the form of plane emission, outward through a light emitting surface 2c. The light emitting surface 2c faces (i) an optical sheet 4 to be irradiated with light or (ii) the liquid crystal display panel 3 to be irradiated with light, and emits light toward the optical sheet 4 or toward the liquid crystal display panel 3. The optical sheet 4 will be described later in detail.

As illustrated in FIGS. 1 and 5, the light guide 2 of one embodiment of the present invention is constituted by (i) a light emitting part 2b having the light emitting surface 2c and (ii) a light guide part 2a that guides light from the light source 6 to the light emitting part 2b. Since there is a step in a boundary between the light emitting part 2b and the light guide part 2a, the light emitting part 2b is larger in thickness than the light guide part 2a. The light emitting part 2b has a shape in which a thickness of the light emitting part 2b gradually decreases as a distance from the light source 6 increases.

The light guide 2 is configured such that, by making use of the step, another light emitting part 2b of another light guide 2 can be partially stacked on the light guide 2a of the light guide 2. This makes it possible to achieve a single large light emitting surface constituted by a plurality of light guides 2 combined with one another.

The light guide 2 can be made of transparent resin such as polycarbonate (PC) or polymethyl methacrylate (PMMA). However, the material from which the light guide 2 is made is not limited to those described above, and can be any material generally used as a light guide. The light guide 2 can be formed for example by injection molding, extrusion molding, thermal press molding, cutting work, or the like. However, a method of forming the light guide 2 is not limited to those described above, and can be any method as long as a property same as that obtained by those methods can be obtained.

### <Specification of Length of Reflection Means 8>

The reflection means 8, which is for causing light entered the light guide 2 to travel toward inside of the light guide 2, is provided on an upper surface of the light guide part 2a. Such reflection means 8 is provided so as to cover a region, of the upper surface of the light guide part 2a of the light guide 2, which faces a light incidence surface 9 of the light guide 2.

As illustrated in (a) through (c) of FIG. 1, the reflection means 8 provided on the upper surface of the light guide part 2a of the light guide 2 should cover a region extending to a certain point. This point is a point at which a light beam La emitted from an edge, of the light source 6, which is closest to the light guide surface 2c strikes the upper surface of the light guide part 2a with an angle of incidence which meets the total reflection condition (i.e., a point P in (c) of FIG. 1).

Note here that, in a case where a light travels from a first medium of higher refractive index to a second medium of lower refractive index, a refraction light of the light becomes parallel with an interface of the first medium and the second medium when an angle of incidence to the second medium reaches a specific angle. Such an angle is called a total reflection critical angle. If the light strikes the interface with an angle of incidence larger than or equal to the total reflection critical angle, then the light is totally reflected by the interface. The total reflection critical angle depends on material from which the light guide 2 is made.

In a case where the reflection means 8 is not provided in a region where the light beam La strikes the upper surface of the light guide part 2a with an angle of incidence smaller than the total reflection critical angle, the light beam La directly leaks out through a surface of the light guide 2 without traveling inside the light guide 2. In view of this, the reflection means 8 needs to cover the region where the light beam La strikes the upper surface of the light guide part 2a with an angle of incidence smaller than the total reflection critical angle.

On the other hand, in a region where the light beam La strikes the upper surface of the light guide part 2a with an angle of incidence larger than or equal to the total reflection critical angle, the light beam La is totally reflected by the light guide 2. That is, none of the light beam La directly leaks out through the surface of the light guide 2. In view of this, the reflection means 8 does not need to cover the region where the light beam La strikes the upper surface of the light guide part 2a with an angle of incidence larger than or equal to the total reflection critical angle.

Specifically, the reflection means 8 is provided in a region specified in the following manner. That is, first, a boundary point (the point P in (c) of FIG. 1) between the region that needs to be covered by the reflection means 8 and the region that does not need to be covered by the reflection means 8 is found by using (i) an angle of inclination of (a) either one of the upper surface and a lower surface, which are parallel with each other, of the light guide part 2a of the light guide 2 to (b) the substrate 7 on which the light source 6 is provided and (ii) the total reflection critical angle. Then, the reflection means 8 is provided so as to cover a region extending to the boundary point (the point P in (c) of FIG. 1). This makes it possible to achieve a light guide unit 1 capable of, with use of minimum-sized reflection means 8, (I) preventing light from directly leaking out from the light guide 2 through the surface of the light guide 2 and thus preventing luminance unevenness and also (II) suppressing an increase in production costs.

This will be more specifically described below with reference to (a) and (c) of FIG. 1.

Assume that an angle between the light beam La and a vertical line M is θ. Note here that the vertical line M extends from an edge, of the light source 6, which is closest to the light emitting surface 2c toward the light incidence surface 9 right above the light source 6. The light beam La passes through an intersection at which the light incidence surface 9 and the vertical line M intersect. In a case where the light beam La strikes the upper surface, of the light guide part 2 of the light guide 2, which is at an angle of inclination φ to the substrate 7, an angle of incidence of the light beam La is θ+φ.

In a region where the angle of incidence θ+φ is larger than or equal to the total reflection critical angle α, the incident light is totally reflected by the light guide 2. That is, such a region does not need to be covered by the reflection means 8.

On the other hand, in a region where the angle of incidence θ+φ is smaller than the total reflection critical angle α, the incident light directly leaks out through the surface of the light guide 2 without traveling inside the light guide 2. That is, such a region needs to be covered by the reflection means 8.

That is, by finding a point at which the angle of incidence θ+φ is equal to the total reflection critical angle α, it is possible to find a boundary point between the region that needs to be covered by the reflection means 8 and the region that does not need to be covered by the reflection means 8.

The angle of inclination φ of the light guide part 2a depends on shape of the light guide 2, whereas the total reflection critical angle α depends on material from which the light guide 2 is made. In view of this, the angle θ can be found through the following equation:

θ=α−φ,where α≧φ (Equation 1)

The angle θ is an angle between (i) the vertical line M and (ii) the light beam passing through the intersection at which the light incidence surface 9 and the vertical line M intersect. The boundary point between the region that needs to be covered by the reflection means 8 and the region that does not need to be covered by the reflection means 8 depends on the angle θ.

Further, the angle of inclination φ influences a thickness of the light guide 2, i.e., a thickness of the surface light source device 31 (refer to FIG. 5). In view of this, the angle of inclination φ needs to be smaller than or equal to the total reflection critical angle α in order to achieve a thin light guide 2.

This is further described with a specific example. For example, in a case where a refractive index n of the light guide 2 is 1.49, the total reflection critical angle α of the light guide 2 can be found through the following equation (Snell's law):

sin α=1/n (Equation 2)

According to Equation 2, the sin α is 0.671141. Based on this, the total reflection critical angle α is found to be 42.15518°.

Further, in a case where the upper surface of the light guide part 2a of the light guide 2 is at the angle of inclination φ of 10° to the substrate 7, the angle θ is found from Equation 1 to be 32.15518°.

Accordingly, the reflection means 8, which causes the light entered the light guide 2 to travel toward inside of the light guide 2, can be provided on the upper surface of the light guide part 2a so as to cover a region, of the upper surface of the light guide part 2a, which faces the light incidence surface 9 and extends from a point P. The point P is one, of intersections of the upper surface of the light guide part 2a and a straight line, which is furthermost from the light source 6 among the intersections. The straight line (i) extends at an angle of 32.15518° to a vertical line extending from an edge, of the light source 6, which is closest to the light emitting surface 2c toward the light incidence surface 9 right above the light source 6 and (ii) passes through an intersection at which the light incidence surface 9 and the vertical line intersect.

### <Case Where Minimum-length Reflection Means 8 is Provided>

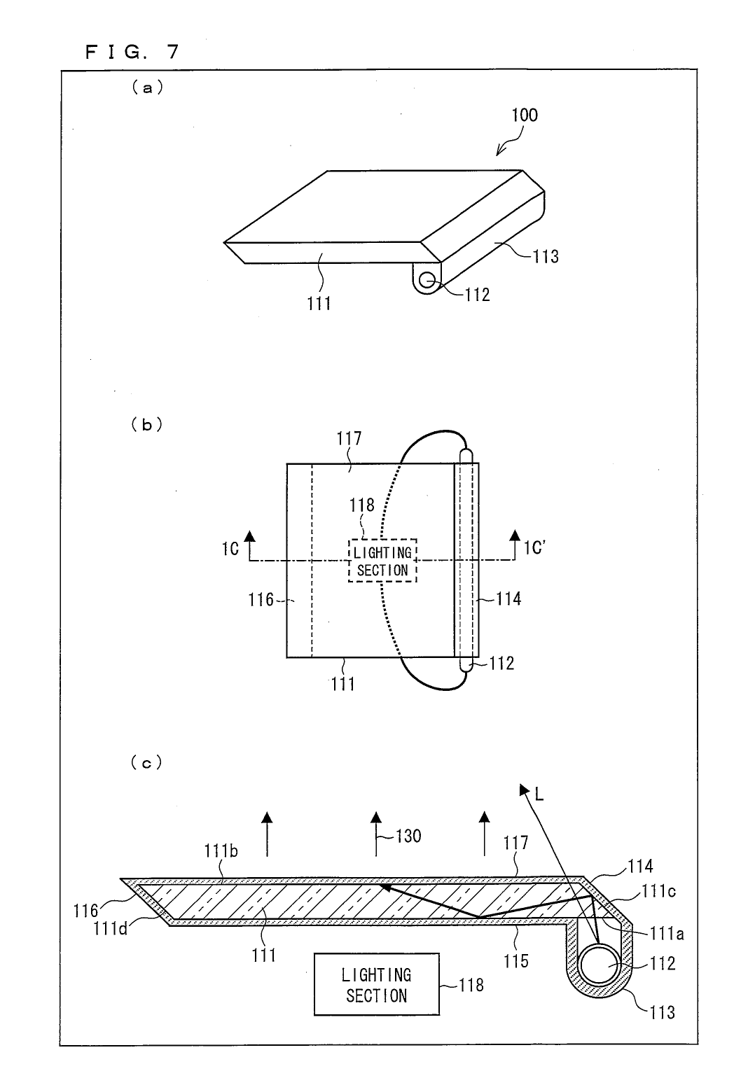

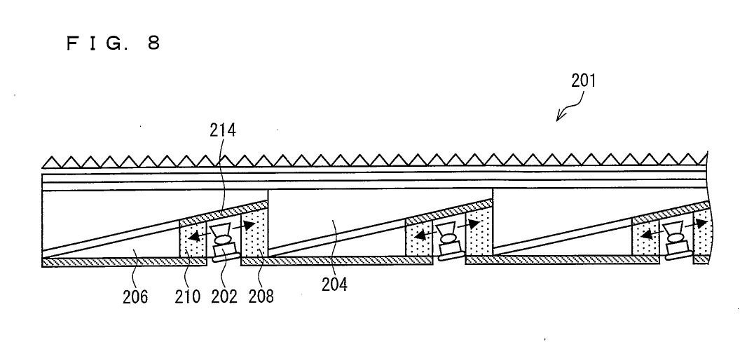

FIG. 6 is a cross-sectional view schematically illustrating how a light guide unit 1b is configured in a case where minimum-length reflection means 8 is provided. On the basis of FIG. 6, how to specify the length of the reflection means 8 is explained.

As illustrated in FIG. 6, the light guide unit 1b is configured such that an angle of inclination φ of either one of upper and lower surfaces of a light guide part 22a of a light guide 22 is equal to a total reflection critical angle α of the light guide 22.

That is, according to the configuration, shape of the light guide part 22a of the light guide 22 and material from which the light guide 22 is made are selected so that the angle of inclination φ is equal to the total reflection critical angle α. The angle of inclination φ is an angle of inclination of (i) either one of the upper and lower surfaces, which are parallel with each other, of the light guide part 22a of the light guide 22 to (ii) a substrate 7 on which a light source 6 is provided. The total reflection critical angle α depends on material from which the light guide 22 is made.

Therefore, an angle θ is found from Equation 1 to be 0. Accordingly, the reflection means 8, which causes light entered the light guide 22 to travel toward inside of the light guide 22, can be provided on the upper surface of the light guide part 22a so as to cover a region, of the upper surface of the light guide part 22a, which faces the light incidence surface 9 and extends from an intersection P. The intersection P is between a straight line extending at the angle θ (=0) and the upper surface of the light guide part 22a.

According to the configuration, it is possible to achieve a light guide unit 1b capable of, with use of minimum-sized reflection means 8, (i) preventing light from directly leaking out from the light guide 22 through the surface of the light guide 22 and thus preventing luminance unevenness and also (ii) suppressing an increase in production costs.

The reflection means 8 is not limited to a particular kind, as long as the reflection means 8 reflects light so that the light is efficiently emitted outward through the light emitting surface 2c (see (a) of FIG. 1) or the like. Note however that, in the present embodiment, a material same as a reflection sheet 5 (described later) is used as the reflection means 8 so as to improve workability.

### <Light Incidence Surfaces 9 and 10>

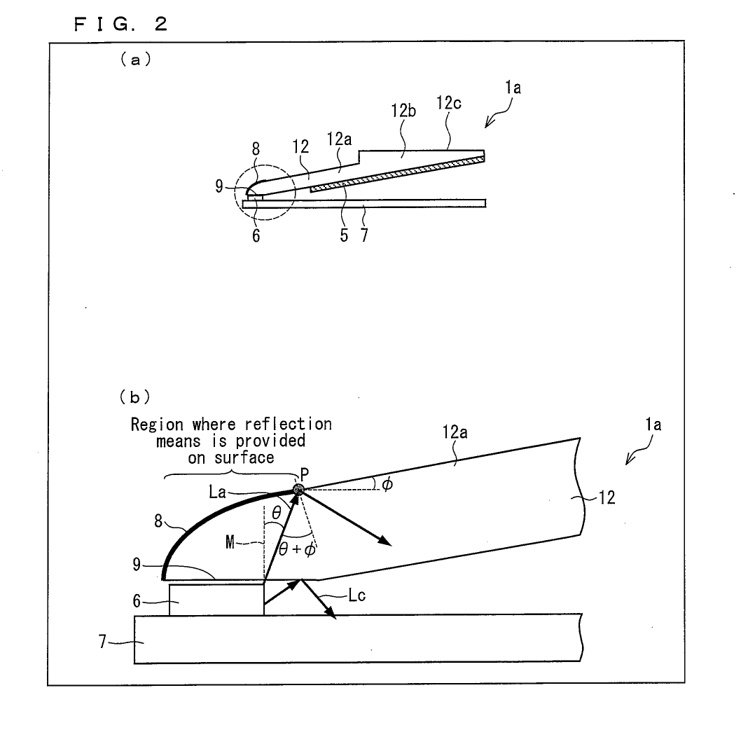

The light incidence surface 9 and a light incidence surface 10 are described below with reference to FIGS. 1 and 2.

In the light guide 2, the light incidence surface 9 serves as a part of an inner surface of a light entrance part of the light guide 2. The light entrance part has a space for accommodating the light source 6 in such a way as to cover the light source 6.

For example, as illustrated in (b) and (c) of FIG. 1, the light guide 2 has the light entrance part, which is (i) constituted by the light incidence surface 9 and a second light incidence surface 10 (i.e., the light incidence surface 10) that is in a direction intersecting the light incidence surface 9 and (ii) formed so as to cover the light source 6.

The light entrance part, which is (i) constituted by the light incidence surface 9 and the second light incidence surface 10 that is in the direction intersecting the light incidence surface 9 and (ii) formed so as to cover the light source 6, is not particularly limited in terms of its shape, as long as the light entrance part has a surface not parallel with the light incidence surface 9.

The surface not parallel with the light incidence surface 9 is, for example, a flat surface at an angle of inclination to the light incidence surface 9, a curved surface with continuously varying angles to the light incidence surface, or the line. Note, however, that the surface is not limited to these examples.

According to the above configuration in which the light source 6 is covered by the light entrance part of the light guide 2, there exists, around the light source 6, the surface not parallel with the light incidence surface 9.

As illustrated in (b) and (c) of FIG. 1, a light Lb, which entered the light guide 2 through the surface (the second light incidence surface 10) not parallel with the light incidence surface 9, contains a lot of light components each of which strikes the upper surface of the light guide part 2a of the light guide 2 with a large angle of incidence (i.e., light components each of which strikes the upper surface with an angle of incidence larger than or equal to the total reflection critical angle that depends on material from which the light guide 2 is made). Such light components eventually travel inside the light guide part 2a by being totally reflected by the light guide part 2a.

While the reflection means 8 of 100% reflectance does not exist, the light guide 2 under the total reflection condition is of 100% reflectance in theory. In view of this, an amount of light reflected by the light guide 2 is increased by causing more light to enter the light guide 2 through the surface not parallel with the light incidence surface 9, because the light entered the light guide 2 through the surface not parallel with the light incidence surface 9 is totally reflected by the light guide 2.

For this reason, according to the configuration, it is possible to achieve a light guide unit 1 that is excellent in use efficiency of light.

Meanwhile, (a) of FIG. 2 is a cross-sectional view schematically illustrating how a light guide unit 1a is configured. (b) of FIG. 2 is a view on the basis of which to explain how to specify a length of the reflection means 8 to be provided in the light guide unit 1a.

As illustrated in (b) of FIG. 2, a light guide 12 has a light entrance part that is constituted only by the light incidence surface 9.

According to the configuration, a light Lc, which strikes the light incidence surface 9 with a large angle of incidence, contains a lot of components that are reflected by the light incidence surface 9. Therefore, the configuration is inferior, in use efficiency of the light source 6, to the foregoing configuration in which the second light incidence surface (i.e., the light incidence surface 10) is formed.

### <Surface Light Source Device 31 and Liquid Crystal Display Device 41>

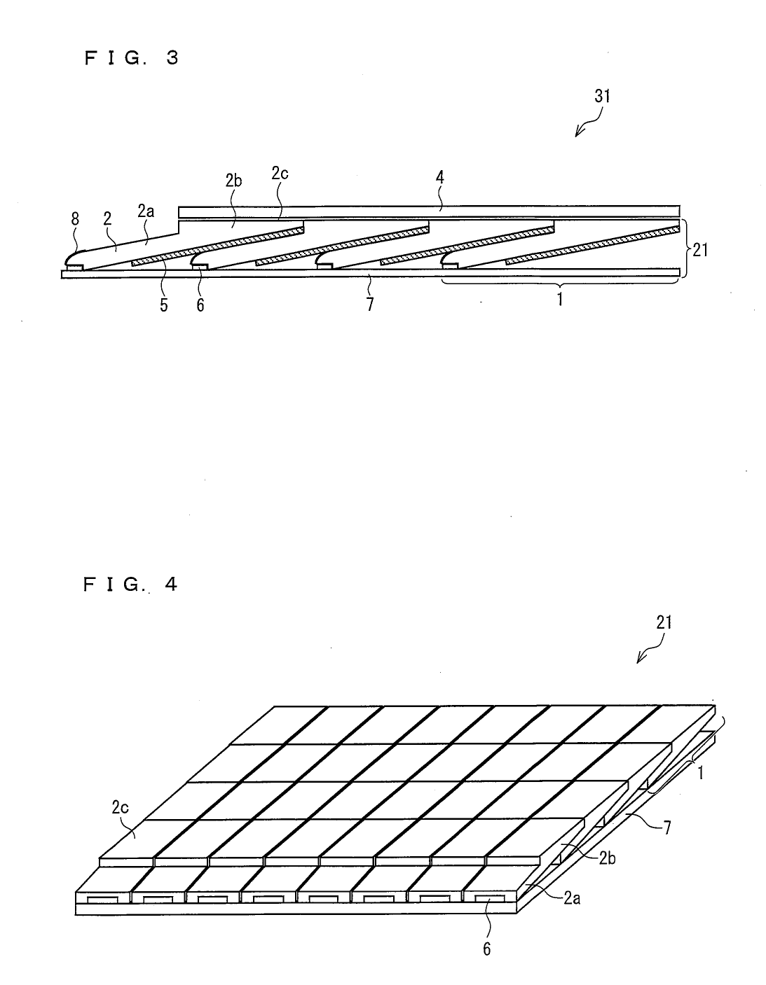

The following description further discusses the surface light source device 31 and the liquid crystal display device of one embodiment of the present invention, with reference to FIGS. 3 through 5.

FIG. 3 is a cross-sectional view schematically illustrating how the surface light source device 31 included in the liquid crystal display device 41 of one embodiment of the present invention is configured.

As illustrated in FIG. 3, the surface light source device 31 of one embodiment of the present invention is configured such that (i) light guide units 1 are combined with one another to form a single large light emitting surface and (ii) an optical sheet 4 is provided on such a light emitting surface.

FIG. 4 is a perspective view schematically illustrating how an illumination device 21 included in the liquid crystal display device 41 of one embodiment of the present invention is configured.

As illustrated in FIG. 4, the illumination device 21 is configured such that the optical sheet 4 is removed from the surface light source device 31 of one embodiment of the present invention as illustrated in FIG. 3.

As illustrated in FIGS. 3 and 4, each light source 6 is provided along an edge, of a light guide part 2a, which is furthermost from a light emitting part 2b of a light guide 2. The light source 6 is not limited to a particular kind; however, in the present embodiment, the light source 6 includes light emitting diodes (LED) each of which is a dot light source.

The light source 6 can include light emitting diodes of different kinds, which emit light of different colors. Specifically, the light source 6 is configured such that a plurality of groups of LEDs are arranged, each of which groups includes light emitting diodes of three colors (i.e., red [R], green [G], and blue [B]). With such a light source 6 which includes a combination of the light emitting diodes of three colors, it is possible for the light emitting surface 2c to emit white light.

Note here that, which colors to combine can be determined as needed depending on (i) color characteristics of the light emitting diodes of respective colors, (ii) a color characteristic, of the surface light source device 31, which is desired for an intended use of the liquid crystal display device 41, and (iii) the like. As an alternative, it is possible to employ LEDs configured such that LED chips of respective different colors are molded into a single package. With such LEDs, it is possible to achieve an illumination device 21 capable of reproducing a wide range of colors.

According to the present embodiment, the liquid crystal display panel 3 illustrated in FIG. 5 is a transmissive liquid crystal display panel, which transmits light from the surface light source device 31 (backlight) so as to carry out a display.

The liquid crystal display panel 3 is not particularly limited in terms of its configuration, and can be any of generally-known liquid crystal display panels depending on the situation. For example, the liquid crystal display panel 3 is constituted by, although not illustrated, (i) an active matrix substrate on which a plurality of TFTs (thin film transistors) are provided, (ii) a color filter substrate facing the active matrix substrate, and (iii) a liquid crystal layer that is provided between the active matrix substrate and the color filter substrate and is sealed with use of a sealing agent.

A substrate 7 is a substrate on which the light source 6 is provided, and is preferably a white substrate so as to increase luminance. Note here that, although not illustrated, the substrate 7 has, on its back surface (i.e., a surface opposite to a surface on which the light source 6 is mounted), drivers for controlling lighting of the LEDs included in the light source 6. That is, the drivers are mounted on the substrate 7 on which the LEDs are mounted. According to the configuration in which the drivers and the LEDs are mounted on the same substrate, the number of substrates and the number of connectors connecting the substrates etc. can be reduced. This makes it possible to reduce costs of the device. In addition, since the number of substrates is small, it is possible to reduce a thickness of the liquid crystal display device 41.

Each reflection sheet 5 is provided so as to be in contact with a lower surface of the light guide 2, in such a way that an end of the reflection sheet 5 is sandwiched between the substrate 7 and an edge portion of the light guide 2. The reflection sheet 5 reflects light so as to cause the light to be efficiently emitted outward through the light emitting surface 2c.

The foregoing optical sheet 4 is constituted by a diffusing plate and an optical sheet having a plurality of functions. The plurality of functions of the optical sheet are selected from various optical functions such as diffusion, refraction, collection of light, and polarization of light.

One example of the optical sheet 4 is a diffusing plate, which is approximately 2 mm to 3 mm in thickness and is provided at a distance of several millimeters from the light emitting surface 2c of the illumination device 21 as illustrated in FIG. 4. Note, however, that the thickness of the diffusing plate and the distance from the light emitting surface 2c of the illumination device 21 are not limited to those described above.

As illustrated in FIG. 3, the diffusing plate is provided so as to (i) cover an entire surface of a single large light emitting surface constituted by a plurality of light emitting surfaces 2c, which is formed by combining the light guide units 1 with one another, at a predetermined distance from the light emitting surface 2c and (ii) face the light emitting surface 2c. The diffusing plate diffuses light emitted from the light emitting surface 2c.

In order to secure uniformity of luminance that is high enough for the surface light source device 31 to sufficiently exert its function, for example, the diffusing plate can further have, stacked on its upper surface, an optical sheet having a plurality of functions such sheet as a diffusing sheet, a prism sheet, a polarized reflection sheet, or the like, which is approximately several hundreds micrometers in thickness.

The above thickness and configuration are mere examples, and therefore the thickness and configuration are not limited to those described above.

The optical sheet having the plurality of functions is made by stacking a plurality of sheets on top of one another on the light emitting surface 2c of the light guide 2. The optical sheet having the plurality of functions uniformizes and collects light emitted from the light emitting surface 2c of the light guide 2, so as to direct the light toward the liquid crystal display panel 3.

That is, examples of the optical sheet having the plurality of functions encompass: a diffusing sheet that collects and diffuses light; a lens sheet that converges light so as to increase luminance in a front direction (i.e., a direction toward the liquid crystal display panel 3); a polarized reflection sheet that reflects one polarization component of light and transmits the other polarization component of the light so as to increase luminance of the liquid crystal display device 41, and the like. These optical sheets each having the plurality of functions are preferably used in an appropriate combination depending on an intended price and performance of the liquid crystal display device 41.

The invention is not limited to the description of the embodiments above, but may be altered within the scope of the claims. An embodiment based on a proper combination of technical means disclosed in different embodiments is encompassed in the technical scope of the invention.

### INDUSTRIAL APPLICABILITY

The present invention is applicable to: a light guide unit constituting a surface light source device; a surface light source device used as a backlight of a liquid crystal display device etc.; and a liquid crystal display device including the surface light source device.

### REFERENCE SIGNS LIST

1, 1a, 1b Light guide unit
2, 12, 22 Light guide
2a, 12a, 22a Light guide part
2b, 12b Light emitting part
2c, 12c Light emitting surface
4 Optical sheet
6 Light source
7 Substrate
8 Reflection means
9 Light incidence surface
10 Second light incidence surface
31 Surface light source device
41 Liquid crystal display device
φ Angle of inclination of light guide part with substrate
α Total reflection critical angle
θ Angle specifying boundary point between region that needs to be covered by reflection means and region that does not need to be covered by reflection means
La Light beam emitted from edge, of light source, which is closer to light emitting surface
P Intersection
M Vertical line

1. A light guide unit, comprising:
a light source;
a light guide being constituted by (i) a light emitting part having a light emitting surface through which light from the light source is emitted in a form of plane emission and (ii) a light guide part for guiding the light from the light source to the light emitting part; and
reflection means provided on an upper surface of the light guide part so as to cause light, which entered the light guide, to travel toward inside of the light guide,
the light guide having a shape that allows for overlap of a neighboring light guide with the light guide,
the reflection means extending from one of first intersections so as to cover a region, of the upper surface of the light guide part, which faces a light incidence surface right above the light source, where: each of the first intersections is an intersection of (a) a straight line extending at an angle θ to a vertical line and passing through a second intersection and (b) the upper surface of the light guide part; the one of the first intersections is furthermost from the light source among the first intersections; the vertical line extends from an edge, of the light source, which is closest to the light emitting surface toward the light incidence surface; and the second intersection is an intersection at which the vertical line and the light incidence surface intersects,
the angle θ satisfying the following Equation 1:
θ=α−φ (Equation 1),
where
φ is an angle of inclination of (I) either one of the upper surface and a lower surface, which are parallel with each other, of the light guide part of the light guide to (II) an extended plane of a substrate on which the light source is provided,
α is a total reflection critical angle which depends on material from which the light guide is made, and
α≧φ.

2. The light guide unit according to claim 1, wherein α=φ.

3. The light guide unit according to claim 1, wherein:
the light incidence surface serves as a part of an inner surface of a light entrance part of the light guide unit, and
the light entrance part has a space for accommodating the light source in such a way as to cover the light source.

4. A surface light source device, comprising:
a light guide unit recited in claim 1; and
an optical sheet on the light emitting surface of the light guide unit.

5. A liquid crystal display device, comprising, as a backlight, a surface light source device recited in claim 4.
